(19) United States
(12) Patent Application Publication
(10) Pub. No.: US 2014/0002983 A1
(43) Pub. Date: Jan. 2, 2014

(54) CONTINUATION POWER SUPPLY SYSTEM AND ELECTRONIC DEVICE USING SAME

(71) Applicant: HON HAI PRECISION INDUSTRY CO., LTD., New Taipei (TW)

(72) Inventor: MENG-CHE YU, New Taipei (TW)

(73) Assignee: HON HAI PRECISION INDUSTRY CO., LTD., New Taipei (TW)

(21) Appl. No.: 13/719,476

(22) Filed: Dec. 19, 2012

(30) Foreign Application Priority Data
Jun. 28, 2012 (TW) 101123234

(51) Int. Cl. G06F 1/18

(52) U.S. Cl. CPC G06F 1/189
USPC 361/679.32

(57) ABSTRACT

A power supply system supplying electrical power to a storage device includes a main board, a first power supply circuit and a first electrical connector positioned on the main board, an expansion board separate from the main board, and a second electrical connector plus a first energy storage circuit positioned on the expansion board. The first power supply circuit provides a first voltage to the storage device. The second electrical connector is detachably connected to the first electrical connector. The first energy storage circuit receives the first voltage from the first power supply circuit, stores energy from the first voltage, and supplies a third voltage to the storage device if the first power supply circuit suddenly stops providing the first voltage.

### BACKGROUND

1. Technical Field

The present disclosure relates to a power supply system, and more particularly, to a continuation power supply system that supplies electrical power to a storage device and an electronic device using the continuation power supply system.

2. Description of Related Art

Storage devices, such as hard disks, are employed in many electronic devices. However, when a power supply system suddenly stops supplying electrical power to an electrical device, a storage device employed in the electrical device, especially a solid state drive (SSD) cannot save data in the process of being written. As a result, the data may be lost.

What is needed, therefore is a power supply system and an electronic device using the power supply system that can overcome the aforementioned problems.

### BRIEF DESCRIPTION OF THE DRAWINGS

The components in the drawing are not necessarily drawn to scale, the emphasis instead being placed upon clearly illustrating the principles of the present disclosure.

FIG. 1 is a schematic block diagram of one embodiment of an electronic device.

### DETAILED DESCRIPTION

Reference will be made to the drawing to describe specific exemplary embodiments of the present disclosure.

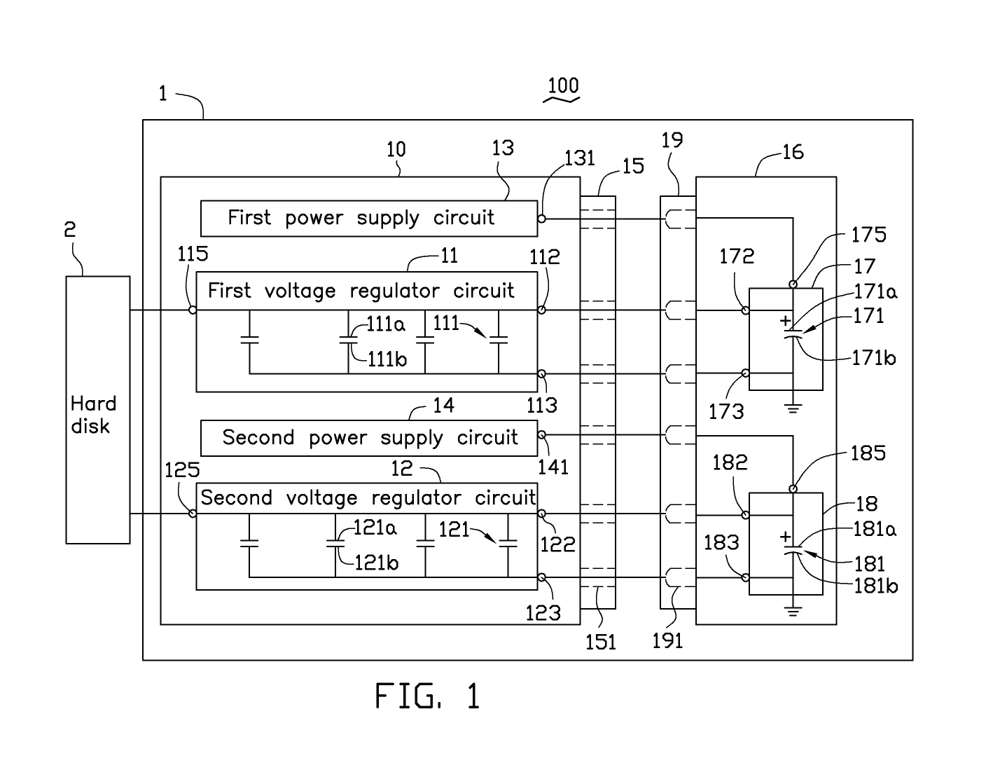

FIG. 1 is a schematic block diagram of one embodiment of an electronic device 100. The electronic device 100 includes a power supply system 1 and a hard disk 2. The power supply system 1 supplies electrical power to the storage device 200. The power supply system 1 includes a main board 10, a first voltage regulator circuit 11, a second voltage regulator circuit 12, a first power supply circuit 13, a second power supply circuit 14, a first electrical connector 15, an expansion board 16, a first energy storage circuit 17, a second energy storage circuit 18, and a second electrical connector 19. The main board 10 and the expansion board 16 are two separate circuit boards. The first voltage regulator circuit 11, the second regulator circuit 12, the first power supply circuit 13, the second power supply circuit 14, and the first electrical connector 15 are positioned on the main board 10. The first energy storage circuit 17, the second energy storage circuit 18, and the second electrical connector 19 are positioned on the expansion board 16. In the present embodiment, the first electrical connector 15 may be a socket, for example. The second electrical connector 16 may be a plug matching with the socket, for example.

The first voltage regulator circuit 11 includes a first input 112, a second input 113, and an output 115. The second voltage regulator circuit 12 includes a first input 122, a second input 123, and an output 125. The first power supply circuit 13 includes an output 131. The second power supply circuit 14 includes an output 141. The first electrical connector 15 includes a plurality of conductive pin channels 151. The first input 112, the second input 113, the first input 122, the second input 123, and the output 131 all have a one-to-one connection with the conductive pin channels 151.

The first energy storage circuit 17 includes a first output 172, a second output 173, and an output 175. The second energy storage circuit 18 includes a first output 182, a second output 183, and an input 185. The second electrical connector 19 includes a plurality of conductive pins 191. The input 175, the first output 172, the second output 173, the input 185, the first output 182, and the second output 183 all have a one-to-one connection with the conductive pins 191.

The second electrical connector 19 is inserted into the first electrical connector 15, and the expansion board 16 is thus electrically connected to the main board 10. In detail, the conductive pin 191 connected to the input 175 plugs into the conductive pin channel 151 connected to the output 131. The conductive pin 191 connected to the first output 172 plugs into the conductive pin channel 151 connected to the first input 112. The conductive pin 191 connected to the second output 173 plugs into the conductive pin channel 151 connected to the second input 113. Accordingly, the first energy storage circuit 17 is detachably connected between the first power supply circuit 13 and the first voltage regulator circuit 11 by using the first electrical connector 15 and the second electrical connector 19.

The conductive pin 191 connected to the input 185 is inserted into the conductive pin channel 151 connected to the output 141. The conductive pin 191 connected to the first output 182 is inserted into the conductive pin channel 151 connected to the first input 122. The conductive pin 191 connected to the second output 183 is inserted into the conductive pin channel 151 connected to the second input 123. Accordingly, the second energy storage circuit 18 is detachably connected between the second power supply circuit 14 and the second voltage regulator circuit 12 by using the first electrical connector 15 and the second electrical connector 19.

The outputs 115 and 125 are connected to the storage device 200.

The first power supply circuit 13 supplies a first voltage to the storage device 200. The second power supply circuit 14 supplies a second voltage to the storage device 200. The first voltage and the second voltage are both the required operating voltages of storage device 200. The first voltage differs from the second voltage. In the present embodiment, the first voltage may be 3.3 volts (V), for example. The second voltage may be 5V, for example.

The first energy storage circuit 17 receives the first voltage via the input 175, stores energy (a first electric potential) from the first voltage, and supplies or continues to supply a third voltage to the storage device 200 when the first voltage to the storage device 200 is cut off by the first power supply circuit 13. In the present embodiment, the first energy storage circuit 17 includes a first storage capacitor 171. The first storage capacitor 171 includes a first end 171a and a second end 171b. The first end 171a is connected to the input 175 and the first output 172. The second end 171b is connected to ground and the second output 173. The first storage capacitor 171 may be a polarized capacitor of large capacity. In the embodiment, a capacitance of the first storage capacitor 171 is greater than 1000 microfarads (uF).

The second energy storage circuit 18 receives the second voltage via the input 185, stores energy (a second electric potential) based on the second voltage, and supplies or continues to supply a fourth voltage to the storage device 200 when the second voltage to the storage device 200 is cut off by the second power supply circuit 14. In the present embodiment, the second energy storage circuit 18 includes a second storage capacitor 181. The second capacitor 181 includes a first end 181a and a second end 181b. The first end 181a is connected to the input 185 and the first output 182. The second end 181b is connected to ground and the second output 183. The second storage capacitor 181 may be a polarized capacitor of large capacity, for example, the capacitance of the second storage capacitor 181 may also be greater than 1000 uF.

The first voltage regulator circuit 11 filters the first voltage and the third voltage, so as to stabilize the first voltage and the third voltage being output to the storage device 200. In the present embodiment, the first voltage regulator circuit 11 includes a plurality of first filter capacitors 111. Each first filter capacitor 111 includes a first end 111a and a second end 111b. First ends 111a of the first filter capacitors 111 are connected to the first input 112 and the output 115. Second ends 111b of the first filter capacitors 111 are connected to the second input 113. Because the conductive pin 191 connected to the first output 172 is plugged into the conductive pin channel 151 connected to the first input 112, and the conductive pin 191 connected to the second output 173 is plugged into the conductive pin channel 151 connected to the second input 113, the first filter capacitor 111 and the first storage capacitor 171 are connected in parallel. Each of the first filter capacitors 111 may be a polarized capacitor of small capacity, for example, the capacitance of each first filter capacitor 111 may be only 20 picofarads (pF). In alternative embodiments, the first voltage regulator circuit 11 may be omitted.

The second voltage regulator circuit 12 filters the second voltage and the fourth voltage, so as to stabilize the second voltage and the fourth voltage being output to the storage device 200. In the present embodiment, the second voltage regulator circuit 12 includes a plurality of second filter capacitors 121. Each second filter capacitor 121 includes a first end 121a and a second end 121b. First ends 121a of the second filter capacitors 121 are connected to the first input 122 and the output 125. Second ends 121b of the second filter capacitors 121 is connected to the second input 123. Because the conductive pin 191 connected to the first output 182 is plugged into the conductive pin channel 151 connected to the first input 122, and the conductive pin 191 connected to the second output 183 is plugged into the conductive pin channel 151 connected to the second input 123, the second filter capacitor 121 and the second storage capacitor 181 are connected in parallel. Each of the second filter capacitors 121 may be a polarized capacitor of small capacity, for example, the capacitance of the second filter capacitors 121 may also be 20 pF. In alternative embodiments, the second voltage regulator circuit 12 may be omitted.

Operation of the electronic device 1 is as follows.

As the first power supply circuit 13 is outputting the first voltage, and the second power supply circuit 14 is outputting the second voltage, the first energy storage circuit 17 receives the first voltage and stores a first electric potential based on the first voltage and the second energy circuit 18 receives the second voltage and stores a second electric potential based on the second voltage. In addition, the first voltage regulator circuit 11 receives and filters the first voltage, and outputs the filtered first voltage to the storage device 200. The second voltage regulator circuit 12 also receives and filters the second voltage, and outputs the filtered second voltage to the storage device 200. The storage device 200 is powered by the first voltage and the second voltage and has the capability of fully writing and storing data being transferred to the storage device 200.

When the first power supply circuit 13 suddenly stops outputting the first voltage, the first energy storage circuit 17 discharges the first electric potential and thus supplies the third voltage to the first voltage regulator circuit 11. The first voltage regulator circuit 11 receives and filters the third voltage received from the first energy storage circuit 17, and outputs the filtered third voltage to the storage device 200. Similarly, if the second power supply circuit 14 suddenly stops outputting the second voltage, either independently or simultaneously with the sudden stopping of the first power supply circuit 13, the second energy storage circuit 18 discharges the second electric potential and thus supplies the fourth voltage to the second voltage regulator circuit 12. The second voltage regulator circuit 12 receives and filters the fourth voltage received from the second power supply circuit 14, and outputs the filtered fourth voltage to the storage device 200. In this way, the storage device 200 continues to be powered by the third voltage and/or the fourth voltage instead of by the first voltage and the second voltage, and any current process of writing and storing data into the storage device 200 will be completed and finished.

Since the power supply system 1 includes the first energy storage circuit 17 and the second energy storage circuit 18, the first energy storage circuit 17 and the second energy storage circuit 18 continue to provide the first electric potential and the second electric potential to the storage device 200, even though the second power supply circuit 14 suddenly stops outputting the second voltage, either independently or simultaneously with the sudden stopping of the first power supply circuit 13. Accordingly, the storage device 200 stores data being written, and there is a reduced risk of data being lost.

Position of the first energy storage circuit 17 and the second energy storage circuit 18 on the expansion board 16, which is detachably connected to the main board 10, allows the first energy storage circuit 17 and the second energy storage circuit 18 to be used for different storage devices 200, without affecting circuit structure or the wiring layouts of the main board 10.

In alternative embodiments, when the storage device 200 operates using only the first voltage without the second voltage, the second energy storage circuit 18 can be omitted. When the storage device 200 operates using only the second voltage without the first voltage, the first energy storage circuit 17 can be omitted.

The first electrical connector 15 and the second electrical connector 19 may be other types of connection. The first electrical connector 15 and the second electrical connector 19 may both be connector pin channels, for example, where the first electrical connector 15 and the second electrical connector 19 are connected with each other via a data line.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A power supply system supplying electrical power to a storage device, comprising:
a main board;
a first power supply circuit positioned on the main board and configured to provide a first voltage to the storage device;
a first electrical connector positioned on the main board, connected to the first power supply circuit, and configured to connect to the storage device;
an expansion board separated from the main board;
a second electrical connector positioned on the expansion board and detachably connected to the first electrical connector; and
a first energy storage circuit positioned on the expansion board, connected to the first power supply circuit when the first electrical connector is connected to the second electrical connector, and configured to connect to the storage device when the first electrical connector is connected to the second electrical connector;
wherein the first energy storage circuit receives the first voltage from the first power supply circuit, stores a first electric potential based on the first voltage, and is configured to supply a third voltage to the storage device when the first power supply circuit suddenly stops providing the first voltage to the storage device.

2. The power supply system of claim 1, further comprising a first voltage regulator circuit positioned on the main board, wherein the first voltage regulator circuit filters the first voltage from the first power supply circuit and is configured to output the filtered first voltage to the storage device.

3. The power supply system of claim 2, wherein the first voltage regulator circuit filters the third voltage from the first energy storage circuit and is configured to output the filtered third voltage to the storage device.

4. The power supply system of claim 3, wherein the first voltage regulator circuit is connected to the first electrical connector and is configured to connect to the storage device, and the first power supply circuit is connected to the first voltage regulator circuit via the first energy storage circuit when the first electrical connector is connected to the second electrical connector.

5. The power supply system of claim 4, wherein the first energy storage circuit comprises a first storage capacitor comprising a first end and a second end, an input, a first output, and a second output, the first end is connected to the input and the first output, the second end is connected to ground and the second output, and when the first electrical connector is connected to the second electrical connector, the first input is connected to the first power supply circuit, the first output and the second output are connected to the first voltage regulator circuit.

6. The power supply system of claim 5, wherein the first voltage regulator circuit comprises at least one first filter capacitor, a first input, a second input, and an output, each first filter capacitor comprises a first end and a second end, the first end of each first filter capacitor is connected to the first input of the first voltage regulator circuit and the output of the first voltage regulator circuit, the second end of each first filter capacitor is connected to the second input of the first voltage regulator, and the output of each first filter capacitor is configured to connect to the storage device.

7. The power supply system of claim 1, further comprising a second power supply circuit positioned on the main board and a second energy storage circuit positioned on the expansion board, wherein the second energy storage circuit is connected to the second power supply circuit and is configured to connected to the storage circuit when the first electrical connector is connected to the second electrical connector, the second power supply circuit is configured to provide a second voltage to the storage device, the second energy storage circuit receives the second voltage, stores a second electric potential based on the second voltage, and is configured to output a fourth voltage to the storage device when the second power supply circuit suddenly stops providing the second voltage to the storage device.

8. The power supply system of claim 7, further comprising a second voltage regulator circuit positioned on the main board, wherein the second voltage regulator circuit is connected to the first electrical connector and is configured to connect to the storage device, the second energy storage circuit is configured to connect to the storage device via the second voltage regulator circuit when the first electrical connector is connected to the second electrical connector.

9. The power supply system of claim 8, wherein the second energy storage circuit comprises a second storage capacitor comprising a first end and a second end, an input, a first output, and a second output, the first end of the second storage capacitor is connected to the input of the second energy storage circuit and the first output of the second energy storage circuit, the second end of the second storage capacitor is connected to ground and the second output of the second energy storage circuit, and when the first electrical connector is connected to the second electrical connector, the first input of the second energy storage circuit is connected to the second power supply circuit, the first output of the second energy storage circuit and the second output of the second energy storage circuit are connected to the second voltage regulator circuit.

10. The power supply system of claim 9, wherein the second voltage regulator circuit comprises at least one second filter capacitor, a first input, a second input, and an output, each second filter capacitor comprises a first end and a second end, the first end of each second filter capacitor is connected to the first input of the second voltage regulator circuit and the output of the second voltage regulator circuit, the second end of each second filter capacitor is connected to the second input of the second voltage regulator, and the output of each second filter capacitor is configured to connect to the storage device.

11. An electronic device, comprising:
a storage device storing data; and
a power supply system supplying electrical power to the storage device, comprising:
a main board;
a first power supply circuit positioned on the main board and providing a first voltage to the storage device;
a first electrical connector positioned on the main board and connected to the first power supply circuit and the storage device;
an expansion board separated from the main board;
a second electrical connector positioned on the expansion board and detachably connected to the first electrical connector; and
a first energy storage circuit positioned on the expansion board and connected between the first power supply circuit and the storage device when the first electrical connector is connected to the second electrical connector;
wherein the first energy storage circuit receives the first voltage from the first power supply circuit, stores a first electric potential based on the first voltage, and supplies a third voltage to the storage device when the first power supply circuit suddenly stops providing the first voltage to the storage device.

12. The electronic device of claim 11, wherein the power supply circuit further comprises a first voltage regulator circuit positioned on the main board, and the first voltage regulator circuit filters the first voltage from the first power supply circuit and outputs the filtered first voltage to the storage device.

13. The electronic device of claim 12, wherein the first voltage regulator circuit filters the third voltage from the first energy storage circuit and outputs the filtered third voltage to the storage device.

14. The electronic device of claim 13, wherein the first voltage regulator circuit is connected between the first electrical connector and the storage device, and the first power supply circuit is connected to the first voltage regulator circuit via the first energy storage circuit when the first electrical connector is connected to the second electrical connector.

15. The electronic device of claim 14, wherein the first energy storage circuit comprises a first storage capacitor comprising a first end and a second end, an input, a first output, and a second output, the first end is connected to the input and the first output, the second end is connected to ground and the second output, and when the first electrical connector is connected to the second electrical connector, the first input is connected to the first power supply circuit, and the first output and the second output are connected to the first voltage regulator circuit.

16. The electronic device of claim 15, wherein the first voltage regulator circuit comprises at least one first filter capacitor, a first input, a second input, and an output, each first filter capacitor comprises a first end and a second end, the first end of each first filter capacitor is connected to the first input of the first voltage regulator circuit and the output of the first voltage regulator circuit, the second end of each first filter capacitor is connected to the second input of the first voltage regulator, and the output of each first filter capacitor is connected to the storage device.

17. The electronic device of claim 11, wherein the power supply system further comprises a second power supply circuit positioned on the main board and a second energy storage circuit positioned on the expansion board, the second energy storage circuit is connected between the second power supply circuit and the storage circuit when the first electrical connector is connected to the second electrical connector, the second power supply circuit provides a second voltage to the storage device, the second energy storage circuit receives the second voltage, stores a second electric potential based on the second voltage, and outputs a fourth voltage to the storage device when the second power supply circuit suddenly stops providing the second voltage to the storage device.

18. The electronic device of claim 17, wherein the power supply system further comprises a second voltage regulator circuit positioned on the main board, the second voltage regulator circuit is connected between the first electrical connector and the storage device, the second energy storage circuit is connected to the storage device via the second voltage regulator circuit when the first electrical connector is connected to the second electrical connector.

19. The electronic device of claim 18, wherein the second energy storage circuit comprises a second storage capacitor comprising a first end and a second end, an input, a first output, and a second output, the first end of the second storage capacitor is connected to the input of the second energy storage circuit and the first output of the second energy storage circuit, the second end of the second storage capacitor is connected to ground and the second output of the second energy storage circuit, and when the first electrical connector is connected to the second electrical connector, the first input of the second energy storage circuit is connected to the second power supply circuit, the first output of the second energy storage circuit and the second output of the second energy storage circuit are connected to the second voltage regulator circuit.

20. The electronic device of claim 19, wherein the second voltage regulator circuit comprises at least one second filter capacitor, a first input, a second input, and an output, each second filter capacitor comprises a first end and a second end, the first end of each second filter capacitor is connected to the first input of the second voltage regulator circuit and the output of the second voltage regulator circuit, the second end of each second filter capacitor is connected to the second input of the second voltage regulator, and the output of each second filter capacitor is connected to the storage device.
